(19) United States
(12) Patent Application Publication
(10) Pub. No.: US 2016/0171810 A1
(43) Pub. Date: Jun. 16, 2016

(54) FLUORESCENT AND PHOSPHORESCENT SIMULTANEOUS DETECTION

(71) Applicant: Toshiba International Corporation, Houston, TX (US)

(72) Inventor: John W. Dossey, North Richland Hills, TX (US)

(21) Appl. No.: 14/572,009

(22) Filed: Dec. 16, 2014

(51) Int. Cl. G07D 11/00; G07D 7/12

(52) U.S. Cl. CPC G07D 11/0084; G07D 7/121

(57) ABSTRACT

A bank note processing system having a single illumination source and a single detector to simultaneously detect both fluorescence and phosphorescence. The bank note processing system includes an optical detection module which has a detector and an illuminator. The illuminator directs a higher intensity light to the bank note in a predetermined measurement area on a conveying path, and the detector measures the bank note's fluorescence. The illuminator then directs a lower intensity light to the bank note, and the detector measures the bank note's phosphorescence. Additional fluorescence measurements and phosphorescence measurements may be obtained in the same manner over a time period as the bank note is transported on the conveying path through the measurement area. The successive fluorescence measurements and phosphorescence measurements over the time period are collected and averaged by averaging circuits, and the optical detection module determines whether the bank note is a counterfeit bank note using the measured fluorescence and the measured phosphorescence.

### BACKGROUND OF THE INVENTION

1. Field of the Invention

The present invention relates to automated currency processing, and, more specifically, to a bank note processing system having a fluorescent and phosphorescent simultaneous detection system.

2. Description of Related Art including Information Disclosed under 37 CFR 1.97 and 1.98

Automated currency processors or bank note processing machines are common in the fields of bulk currency processing and are typically used by central banks, large commercial banks, print works, cash in transit, or other entities that require processing of large amounts of currency.

In operation, bank notes that require processing are fed into the automated currency processing machine by a feeder. The term “bank note” (or “note”) as used herein may generally include bills of different currencies, checks, or other instruments that are typically processed by a banking entity. The bank notes then travel down a conveyor past a number of detector modules which detect various characteristics of the bank note. For instance, the detector modules may determine denomination, authenticity, bank note condition, or other desired characteristics of a bank note. Based on the characteristics detected, the bank note may then be routed to a number of different pockets for collation or destruction. These pockets may enable the automated currency processing machine to sort notes by fitness level, denomination, origin, authentication, or other desired characteristics.

Typically, fluorescent information and phosphorescent information are printed on a bank note to be processed by a bank note processing machine. A bank note processing machine may include a first illumination source that may be used to excite the fluorescent printed information such that fluorescence occurs, and a second illumination source light that may be used to excite the phosphorescent printed information such that phosphorescence occurs. A bank note processing machine may include a first detector that may be used to detect the fluorescence and a second detector that may be used to detect the phosphorescence. A particular bank note with a particular type of ink would have a known level of fluorescence and phosphorescence. Accordingly, taken together, the fluorescence and the phosphorescence detected may be used to determine whether the bank note being processed is a counterfeit bank note or possibly a worn bank note. It is desirable to develop a bank note processing machine that can use a single illumination source and a single detector to simultaneously detect both fluorescence and phosphorescence.

### BRIEF DESCRIPTION OF THE SEVERAL VIEWS OF THE DRAWING(S)

The present invention will be more fully understood by reference to the following detailed description of the preferred embodiments of the present invention when read in conjunction with the accompanying drawings, in which like reference numbers refer to like parts throughout the views wherein:

FIG. 1 depicts a block diagram of a basic bank note processing machine, illustrating the location of the detector within the processing stream;

FIG. 2 depicts a diagram of an optical detection apparatus module in accordance with an illustrative embodiment of the present disclosure; and

FIG. 3 depicts a chart for the timing of operations of the optical detection module shown in FIG. 2.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

### DETAILED DESCRIPTION OF THE INVENTION

Illustrative embodiments of the present disclosure are described in detail herein. In the interest of clarity, not all features of an actual implementation may be described in this specification. It will of course be appreciated that in the development of any such actual embodiment, numerous implementation specific decisions must be made to achieve the specific implementation goals, which will vary from one implementation to another. Moreover, it will be appreciated that such a development effort might be complex and time-consuming, but would nevertheless be a routine undertaking for those of ordinary skill in the art having the benefit of the present disclosure. To facilitate a better understanding of the present disclosure, the following examples of certain embodiments are given. In no way should the following examples be read to limit, or define, the scope of the disclosure.

For purposes of this disclosure, a processor may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, a processor may be a personal computer, a network storage device, or any other suitable device and may vary in size, shape, performance, functionality, and price. The processor may include random access memory (RAM), one or more processing resources such as a central processing unit (CPU) or hardware or software control logic, ROM, and/or other types of nonvolatile memory. Additional components of the processor may include one or more disk drives, one or more network ports for communication with external devices as well as various input and output (I/O) devices, such as a keyboard, a mouse, and a video display. The processor may also include one or more buses operable to transmit communications between the various hardware components.

For the purposes of this disclosure, computer-readable media may include any instrumentality or aggregation of instrumentalities that may retain data and/or instructions for a period of time. Computer-readable media may include, for example, without limitation, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), flash memory; and/or any combination of the foregoing.

The term “fluorescence” as used herein refers to the simultaneous emission of light with the wave length shifted by a substance that has absorbed light or other electromagnetic radiation. The term “phosphorescence” as used herein refers to emission of light whose intensity decreases over time from a substance following exposure to and removal of incident radiation.

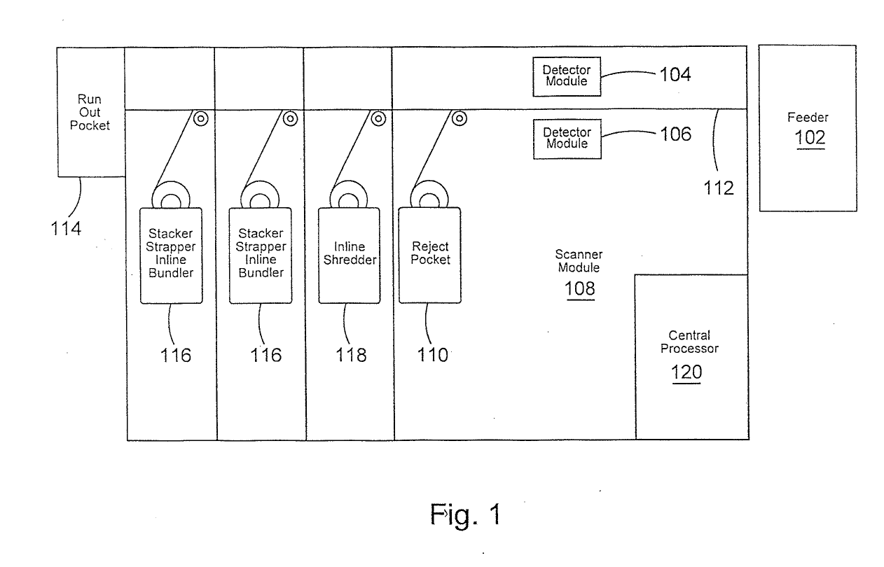

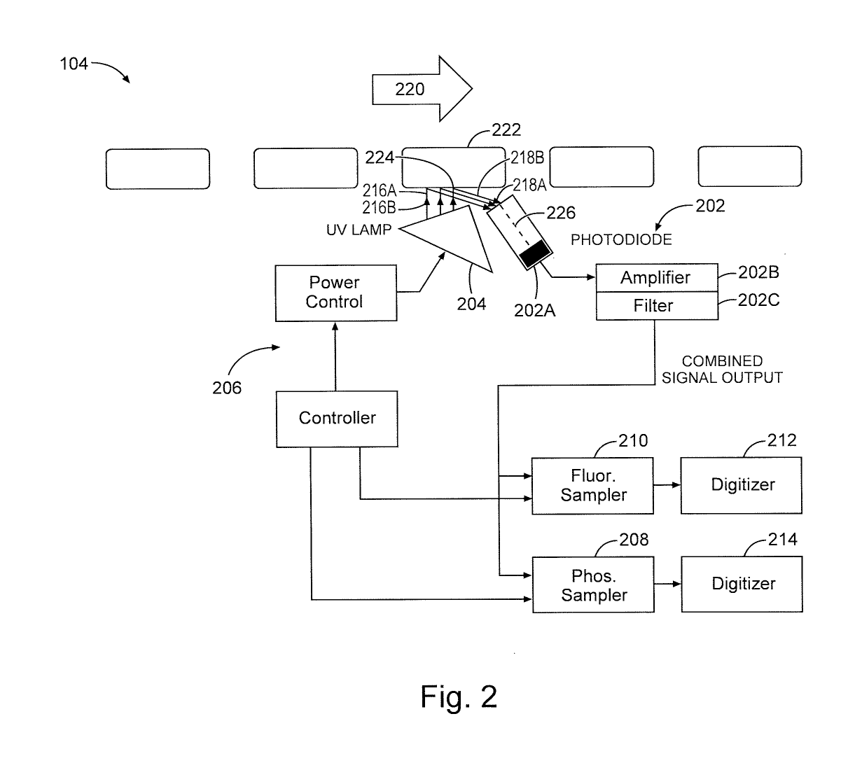

FIG. 1 depicts a block diagram of a bank note processing machine according to one embodiment of the present disclosure, highlighting the location of the detector modules with respect to the processing stream. A bank note is first stripped from a stack of notes in the feeder (102) and sent along a conveying path (112) to the scanner module (108). Within the scanner module (108) is an area centered on the conveying path (112) in which one or more detector modules (104, 106) may be located. The detector modules (104, 106) may be located above, below, or both above and below the conveying path to detect measurements from both the front and the back of the bank note. The detector modules (104, 106) may be any suitable detectors known to those of ordinary skill in the art, having the benefit of the present disclosure. For instance, in certain illustrative embodiments, the detector modules (104, 106) may be ultraviolet detectors which may check the note for soiling. In accordance with certain illustrative embodiments of the present disclosure, at least one of the detector modules (e.g., 104) may be an optical detection module having a single illumination source and a single fluorescence and phosphorescence detector as discussed in more detail in conjunction with FIG. 2 below. The detector modules in the scanner module (108) may be used to identify counterfeit bank notes, damaged bank notes or other desirable characteristics.

Moreover, although two detector modules (104, 106) are shown in FIG. 1, the present disclosure is not limited to any specific number of detector modules. Accordingly, fewer or more detector modules may be used without departing from the scope of the present disclosure.

The bank notes may travel along the transport path (112) past the detector modules (104, 106). The bank notes are then directed to a final disposition component, which may comprise a pocket (114) for collection of processed bank notes, one or more strappers (116) for strapping the bank notes in bundles, and a means for depositing the bank notes into the pocket by pulling the bank notes from the bank note processing path or transport device. For instance, in certain implementations, counterfeit bank notes identified by the optical detection module (104) may be directed to a designated pocket (110) where they may be inspected and/or rejected or they may be directed to an inline shredder (118) where they may be shredded.

Processing of the bank notes may be controlled by a central processor (120), which may be a processor that controls the timing of the system as well as activation of the detectors and control of bank note disposition. The central processor (120) may either be a single processing unit or it may consist of multiple processors. Computer-readable media may also be present, providing storage capacity for the computer code which controls the processor's actions as well as other parameters relating to operation of the system. The central processor (120) is capable of running the stored program steps from the accessible memory. As discussed above, the processor acting as the central processor (120) may be a dedicated general purpose computer, an embedded RISC or CISC computer processor, a DSP, or the like.

FIG. 2 depicts a diagram of an optical detection module (104) in accordance with illustrative embodiments of the present disclosure. As shown in FIG. 2, the detector module may comprise an illuminator (204) and a detector (202). As further shown in FIG. 2, the detector (202) may include a photodiode (202A), an amplifier (202B), and a filter (202C). In certain embodiments, the detector (202) may be positioned such that the optical axis of the detector (226) is perpendicular to the measurement area (224).

In accordance with certain illustrative embodiments of the present disclosure, the illuminator (204) may emit UV light of wavelengths between 320 to 400 nm that alternates between two intensities at a fixed clocking frequency. In certain embodiments, the illuminator (204) may be positioned such that the light from the illuminator (216A, 216B) is emitted perpendicularly to the measurement area (224).

In accordance with an illustrative implementation of the present disclosure, a bank note (222) is directed along a conveying path (112) in the direction shown by the arrow (220). As the bank note (222) moves along the conveying path (112) into the measurement area (224), the illuminator (204) directs a particular wavelength of light at a predetermined frequency onto the portion of the bank note (222) in the measurement area (224). When higher intensity light denoted by arrows (216A) is directed to the bank note (222), the detector (202) detects a fluorescence emission from the bank note (222). The detected fluorescence measurement (218A) provides a measure of emissions of light by the bank note (222) in response to the higher intensity light (216A) from the illuminator (204). A particular bank note with a particular type of ink would have a particular known level of fluorescence for a given applied light intensity and frequency that could be used to determine if the bank note is counterfeit, for example.

After the higher intensity light (216A) from the illuminator (204) is reduced to lower intensity light, denoted by arrows (216B), or completely turned off, the detector (202) detects phosphorescence emission from the bank note (222). The detected phosphorescence measurement (218B) provides a measure of emissions of light by the bank note (222) following exposure to and removal of incident radiation, in this case the reduction to a lower intensity light (216B) or to no light from the illuminator (204). Like fluorescence, a particular bank note with a particular type of ink would have a particular known level of phosphorescence for a given applied light intensity and frequency that could be used to determine if the bank note is counterfeit, for example.

As the bank note (222) is moved along the conveying path (112), another portion of the bank note (222) enters the measurement area (224). The illuminator (204) directs a higher intensity light (216A) onto this portion of the bank note (222) in the measurement area (224), and the detector (202) detects another fluorescence measurement. After the higher intensity light (216A) from the illuminator (204) on this portion of the bank note (222) is reduced to a lower intensity light (216B) or completely turned off, the detector (202) detects another phosphorescence measurement. Additional fluorescence measurements and phosphorescence measurements may be obtained in the same manner over a time period. The successive fluorescence and phosphorescence measurements over the time period are collected and averaged by averaging circuits (208, 210). In certain illustrative embodiments, the successive fluorescence and phosphorescence measurements collected and averaged by the averaging circuits (208, 210) may be coordinated by digital synchronizing circuits (212, 214) to produce continuous electric signal outputs for fluorescence and phosphorescence.

In accordance with certain illustrative embodiments, a processor (206) may control the operation of the illuminator (204) and the detector (202). The frequency of the illuminator (204) and the timing of the detection made by the detector (202) may be based on the speed of the conveying path (112). Moreover, the processor may process the fluorescence and phosphorescence measurements from the averaging circuits (208, 210) or the output signals from the digital synchronized circuits (212, 214) and use them to determine if the bank note is a counterfeit bank note. Counterfeit determination can be based on comparing the average fluorescence and phosphorescence values for a note with known or prior measured values for the particular note under the applied lighting frequency and intensity conditions, for example. In certain illustrative embodiments, the processor may be the central processor (120).

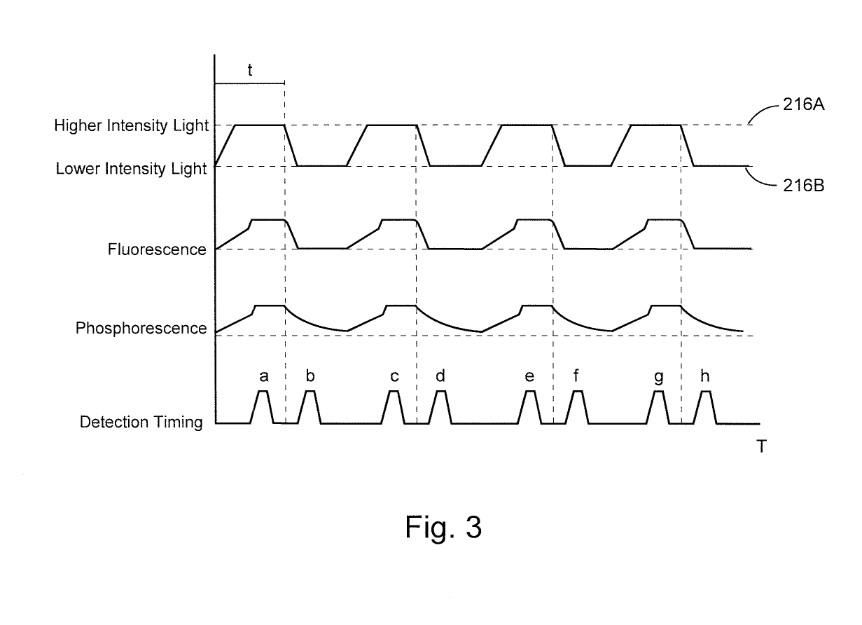

FIG. 3 depicts a chart for the timing of operations of the optical detection module (104) shown in FIG. 2 in accordance with illustrative embodiments of the present disclosure. As shown in the top graph line of FIG. 3, the illuminator (204) alternates between the higher intensity light (216A) and the lower intensity light (216B) at a predetermined frequency (t) over a time period (T). Fluorescence of the bank note (222) is measured by the detector (202) each time the illuminator (204) emits the higher intensity light (216A). Phosphorescence of the bank note (222) is measured by the detector (202) each time the illuminator (204) emits the lower intensity light (216B) or is turned completely off. Successive fluorescence measurements (a, c, e, g) over the time period (T) are collected and averaged by the averaging circuit (210). The successive phosphorescence measurements (b, d, f, h) over the time period (T) are collected and averaged by the averaging circuit (208). In certain embodiments, multiple successive fluorescence measurements may be detected each time the illuminator (204) emits the higher intensity light (216A) and multiple successive phosphorescence measurements may be detected each time the illuminator (204) emits the lower intensity light (216B) or is turned completely off.

Therefore, the present invention is well-adapted to carry out the objects and attain the ends and advantages mentioned as well as those which are inherent therein. While the invention has been depicted and described by reference to exemplary embodiments of the invention, such a reference does not imply a limitation on the invention, and no such limitation is to be inferred. The invention is capable of considerable modification, alternation, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects. The terms in the claims have their plain, ordinary meaning unless otherwise explicitly and clearly defined by the patentee.

What is claimed is:

1. An optical detection module, comprising:
a detector configured to detect fluorescence and phosphorescence of a bank note in a predetermined measurement area on a conveying path;
an illuminator configured to alternately emit a light of a higher intensity and a light of a lower intensity to the measurement area over a time period;
a processor configured to control the detector to detect fluorescence and phosphorescence of the bank note, wherein fluorescence is detected when the illuminator emits the higher intensity light and phosphorescence is detected when the illuminator emits the lower intensity light; and
at least one averaging circuit to collect and average successive detections of each fluorescence and phosphorescence over the time period.

2. The optical detection module of claim 1 further comprising at least one digital synchronizing circuit configured to coordinate the collected and averaged detections from the averaging circuit to provide a continuous electric signal output of the bank note's detected fluorescence and phosphorescence.

3. The optical detection module of claim 1, wherein the processor determines whether the bank note is a counterfeit note based on the measured fluorescence and phosphorescence of the bank note.

4. The optical detection module of claim 1, wherein the optical axis of the detector is perpendicular to the measurement area.

5. The optical detection module of claim 1, wherein the light from the illuminator is emitted perpendicular to the measurement area.

6. The optical detection module of claim 1, wherein the illuminator contains no filter and the detector contains no lens.

7. The optical detection module of claim 1, wherein the detector comprises a photodiode, at least one amplifier, and at least one filter.

8. A bank note processing system comprising:
a conveyor configured to transport a bank note having a front and a back along a conveying path;
at least one optical detection module, wherein the optical detection module comprises
a detector configured to detect fluorescence and phosphorescence of a bank note in a predetermined measurement area on a conveying path;
an illuminator configured to alternately emit a light of a higher intensity and a light of a lower intensity to the measurement area over a time period;
a processor configured to control the detector to detect fluorescence and phosphorescence of the bank note, wherein fluorescence is detected when the illuminator emits the higher intensity light and phosphorescence is detected when the illuminator emits the lower intensity light; and wherein the processor determines whether the bank note is a counterfeit note based on the measured fluorescence and phosphorescence of the bank note; and
at least one averaging circuit to collect and average successive detections of each fluorescence and phosphorescence over the time period; and
a sorting unit configured to sort the bank note according to the determination by the optical detection module.

9. The bank note processing system of claim 8, wherein the optical detection module further comprises at least one digital synchronizing circuit configured to coordinate the collected and averaged detections from the averaging circuit to provide a continuous electric signal output for the bank note's detected fluorescence and phosphorescence.

10. The bank note processing system of claim 8, wherein the optical axis of the detector is perpendicular to the measurement area.

11. The bank note processing system of claim 8, wherein the light from the illuminator is emitted perpendicular to the measurement area.

12. The bank note processing system of claim 8, wherein the illuminator contains no filter and the detector contains no lens.

13. The bank note processing system of claim 8, wherein the detector comprises a photodiode, at least one amplifier, and at least one filter.

14. The bank note processing system of claim 8, wherein one optical detection module is located above the conveying path to detect fluorescence and phosphorescence of the front of the bank note and another optical detection module is located below the conveying path to detect fluorescence and phosphorescence of the back of the bank note.

15. A method of identifying a counterfeit bank note comprising:
directing a bank note to an optical detection module along a conveying path;
alternately emitting a light of a higher intensity and a light of a lower intensity from an illuminator to a measurement area on the conveying path over a time period;
detecting fluorescence and phosphorescence from the bank note with a detector, wherein fluorescence is detected when the illuminator emits the higher intensity light and phosphorescence is detected when the illuminator emits the lower intensity light;
averaging successive detections of each fluorescence and phosphorescence over the time period; and
determining whether the bank note is a counterfeit note based on the measured fluorescence and phosphorescence of the bank note.

16. The method of claim 15, where detecting fluorescence and phosphorescence from the bank note comprises detecting the fluorescence and the phosphorescence when the optical axis of the detector is perpendicular to the measurement area.

17. The method of claim 15, where alternately emitting a light of a higher intensity and a light of a lower intensity from an illuminator comprises emitting light perpendicular to the measurement area.

18. The method of claim 15, where detecting fluorescence and phosphorescence from the bank note comprises detecting the fluorescence and the phosphorescence without lens on the detector.

19. The method of claim 15, where alternately emitting a light of a higher intensity and a light of a lower intensity from an illuminator comprises emitting light to the measurement area without a filter.

20. The method of claim 15, where detecting fluorescence and phosphorescence from the bank note comprises detecting the fluorescence and the phosphorescence with a photodiode, at least one amplifier, and at least one filter.
